(19) United States
(12) Patent Application Publication
(10) Pub. No.: US 2023/0245484 A1
(43) Pub. Date: Aug. 3, 2023

(54) DOCUMENT ANALYZER FOR RISK ASSESSMENT

(71) Applicant: DocuSign, Inc., San Francisco, CA (US)

(72) Inventors: Katheryn Anne Simpson, San Francisco, CA (US); Samantha Lou Voelkel, Coarsegold, CA (US)

(21) Appl. No.: 17/586,783

(22) Filed: Jan. 28, 2022

(51) Int. Cl. G06V 30/413; G06V 30/42; G06N 20/20; G06F 16/93; H04L 9/32

(52) U.S. Cl. CPC G06V 30/413; G06V 30/42; G06N 20/20; G06F 16/93; H04L 9/3247

(57) ABSTRACT

A document analysis system uses trained machine learning models to assess risks to a potential signer of a document. The document analysis system receives a document for analysis along with information about the document type and identification of jurisdictions whose regulations apply to the document. A content analysis model associated with the document type compares the document to known documents of the same document type and generates a risk value associated with signing the document that is based on differences between the document and the known documents of the same document type. A jurisdictional analysis model classifies document clauses according to whether they meet certain requirements of documents according to the regulations of the jurisdiction. The model outputs are used to generate a document summary that a user can interact with to review the document in an informed manner.

### TECHNICAL FIELD

The disclosure generally relates to document management, and specifically to use of machine learning models to develop assessments of document contents.

### BACKGROUND

Document risk analysis is restricted to individuals or entities that can afford the time and cost to employ lawyers to review documents. This kind of traditional legal review is out of reach for many people and, since it requires individual document review by lawyers or other industry experts, the process of reviewing a single document can include lengthy time lags, especially when documents are many pages long. As a result, many people end up skimming documents for keywords or phrases or they simply assume that they understand what is described in the document. Not only can this behavior be dangerous to a person who may not truly understand what they are signing, but it can also delay signing times, for example, if a potential signer makes calls and waits on messages to clarify what is in a document.

### SUMMARY

A document review system helps users to identify aspects of a document that should receive extra review prior to signing. This empowers users to better understand what they are agreeing to when signing documents.

A user can upload a document for review by a document analysis system. A document analysis system interface prompts the user to provide further information about the document such as the document type and jurisdictions or organizations with which the document is associated. The document analysis system reviews the documents using two types of machine learning models. The first set of machine learning models generates a risk value associated with the likelihood that signing the document may be risky to the user. The risk value is generated based at least in part on differences between past documents of the same document type and the document under review. The second set of machine learning models analyzes the document clauses with respect to rules and regulations of the jurisdictions and organizations that the user indicated for the document. The document analysis system identifies clauses of the document that are likely to not comply with the rule sets. The results of the document analysis are combined into a document summary and presented for review by the user.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 illustrates a system environment in which documents are sent by users for risk analysis, in accordance with an example embodiment.

FIG. 2 is a high level block diagram of a system architecture of the document analysis system, in accordance with an example embodiment.

FIG. 3 is a block diagram illustrating a process of analyzing a document by modules of the document analysis system, in accordance with an example embodiment.

FIG. 4 illustrates an example user interface for reviewing a document summary, in accordance with an embodiment.

FIG. 5 is a flow diagram illustrating a process of analyzing a document and generating a document summary, in accordance with an example embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

System Overview

A document analysis system uses trained machine learning models to assess risks to a potential signer of a document. The document analysis system receives a document for analysis along with information about the document type and identification of jurisdictions whose regulations apply to the document. A content analysis model associated with the document type compares the document to known documents of the same document type and generates a risk value associated with signing the document that is based on differences between the document and the known documents of the same document type. A jurisdictional analysis model classifies document clauses according to whether they meet certain requirements of documents according to the regulations of the jurisdiction. The model outputs are used to generate a document summary that a user can interact with to review the document in an informed manner.

As an example, the document analysis system may be helpful for potential signatories who are not well versed in certain jurisdictional regulations or in the requirements of certain types of contracts. For example, a college student renting her first apartment may not be familiar with what clauses should be included in a rental agreement and may not be aware of certain requirements of the state where she has moved for school. The document analysis system 130 will help the student to determine whether some aspects of a rental agreement should be reviewed or changed before signing. As another example, an industry executive who has to review many documents every day may benefit from having a system double check that the documents all comply with regulations in the various cities where they will be filed. The document analysis system enables the businessperson to analyze many documents associated with many different jurisdictions ata scale and speed that would not be otherwise possible.

FIG. 1 illustrates a system environment 100 in which documents are sent by users for risk analysis, in accordance with an example embodiment. The system environment 100 allows users to send documents to a document analysis system 130 which compares the documents to past documents of the same document type to generate a risk score that helps the user understand risks of signing the document and potential issues with presence and/or phrasing of certain document clauses. The document analysis system 130 can further analyze the document in view of known jurisdictional rules associated with the document and can flag any issues accordingly. As illustrated in FIG. 1, the system environment 100 includes a user device 110 and the document analysis system 130, each communicatively interconnected via a network 120. In some embodiments, the system environment 100 includes components other than those described herein. For the purposes of concision, web servers, data centers, and other components associated with an online system environment are not shown in the embodiment of FIG. 1.

The user device 110 is a device by which a user can communicate with the document analysis system 130. In some embodiments, the user device 110 can provide documents for analysis or storage (or instructions to create or edit documents) to a system associated with the document analysis system 130, such as a document management system. The user device 110 is a computing device capable of transmitting or receiving data over the network 120. The user device 110 enables a user to view results of the analysis of the document by the document analysis system 130, such as via an interface. The user device 110 may also enable a user to create or provide documents to a document management system, or to access documents stored at a document management system.

The document analysis system 130 can be a server, server group, or cluster (including remote servers), or another suitable computing device or system of devices. In some implementations, the document analysis system may be a subset of a document management system (not illustrated in FIG. 1) which facilitates storage, download, editing, and review of documents, among other actions. In some embodiments, the document analysis system 130 communicates with one or more user devices 110 over the network 120 to receive and provide information (e.g., documents or document analyses). In alternate embodiments, some or all of the functionality of the document analysis system 130 may be included in a plug-in software component to add the document analysis functionality to another software system, such as a browser. The document analysis system 130 uses trained machine learning models to generate predictions about risk levels associated with signing documents. The document analysis system 130 also reviews documents for compliance with rules within certain jurisdictions. For example, the document management system can inform a user reviewing an apartment lease in a city if a clause that is required by a city ordinance is missing from the document. It should be noted that although the examples given herein illustrate a single user device 110, the document analysis system 130 can coordinate analysis of any number of documents for any number of user devices 110, users, or accounts, and for any number of entities or organizations.

The network 120 transmits data within the system environment 100. The network 120 may be a local area or wide area network using wireless or wired communication systems, such as the Internet. In some embodiments, the network 120 transmits data over a single connection (e.g., a data component of a cellular signal, or Wi-Fi, among others), or over multiple connections. The network 120 may include encryption capabilities to ensure the security of customer data. For example, encryption technologies may include secure sockets layers (SSL), transport layer security (TLS), virtual private networks (VPNs), and Internet Protocol security (IPsec), among others.

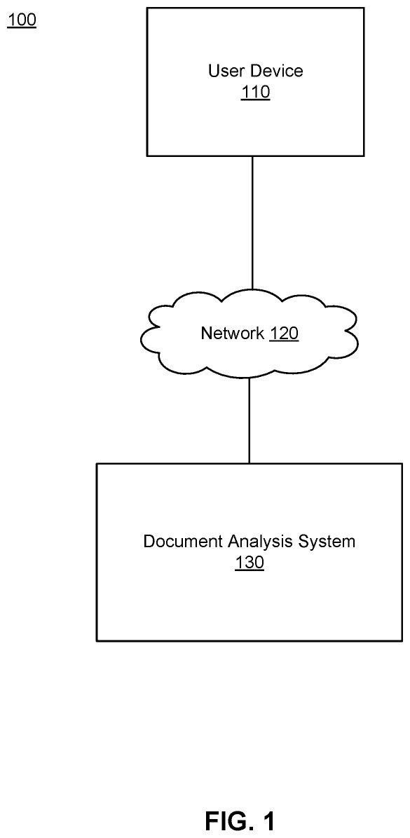

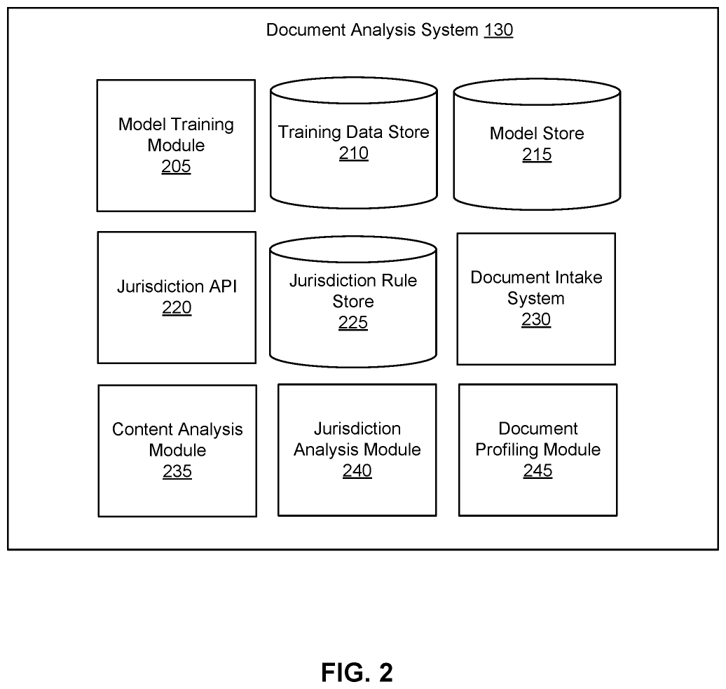

FIG. 2 is a high level block diagram of a system architecture of the document analysis system 130, in accordance with an example embodiment. The document analysis system 130 receives documents for analysis from user devices 105 (or from other entities associated with a document management system) and reviews the documents for compliance with jurisdictional rules. The document analysis system 130 also generates a risk score for each document that can be interpreted by a user to better understand possible issues with clauses of the document. The document analysis system 130 includes a model training module 205, a training data store 210, a model store 215, a jurisdiction application programming interface (API) 220, a jurisdiction rule store 225, a document intake system 230, a content analysis module 235, a jurisdiction analysis module 240, and a document profiling module 245. Computer components such as network interfaces, security functions load balancers, failover servers, management and network operations consoles, and the like are not shown so as to not obscure relevant details of the system architecture. Additionally, document analysis system 130 may contain more, fewer, or different components than those shown in FIG. 2 and the functionality of the components as described herein may be distributed differently from the description herein.

The model training module 205 generates and trains machine learning models for use by the document analysis system 130 in reviewing documents. The machine learning models trained by the model training module 205 may be based on any appropriate machine learning algorithms including, but not limited to, linear regression, logistic regression, decision trees, support vector machines, random forests, gradient boosting algorithms, and the like. In some cases, the models generated by the model training module 205 may be neural network models with trained weights. The model training module 205 may retrain models periodically, when new training data is received for a certain model category, and/or when training is initiated by an administrator of the document analysis system 130. In one embodiment, the model training module 205 trains two sets of models for the document analysis system 130.

The first set of models are content analysis models for use by the content analysis module 235 to review and compare documents to past documents of a similar document type. The content analysis models are trained to receive a document as input and to output a risk score or risk value that represents a likelihood that there are issues present in the document that a user will want to review before signing. In some embodiments, the model training module 205 also generates content analysis models that identify differences between clauses of documents of the same type as a document presented for review. The model training module 205 may train a separate content analysis model for each type of document. For example, a model may be trained to analyze clauses of a rental agreement, and a separate model may be trained to analyze clauses of an employment contract. To train a content analysis model, the model training module 205 accesses training data in the form of documents of the same type as the stored in the training data store 210 in the form of labeled documents. The training labels may be generated by human operators or may be based on review of past documents that have been analyzed by the system. Training labels may include identification of document type, indication of clauses within a document, identification of clause types, standard length of a document, document dates and deadlines, number of signatories to a document, and specification of important words or phrases that should or should not be included within certain clauses of the document. The content analysis machine learning models are trained to generate a risk score that represents an extent to which attributes of a given document differ from expected attributes of documents of the same document type.

The second set of models generated by the model training module 205 are jurisdictional models that are trained to review a document for compliance with rules associated with legal jurisdictions and/or organizational rules. In some embodiments, the model training module 205 trains separate models for separate jurisdictions and may train separate models associated with different document types within each jurisdiction. The jurisdictional models may be trained on labeled training data about similar document types, as stored in the training data store 210. Additionally, the jurisdictional models may be trained on rule sets stored in a jurisdiction rule store 225. In some embodiments, training the jurisdictional models comprises updating the access of the model to newly received or updated sets of jurisdiction rules and custom rules. The model training module 205 trains the jurisdictional models to compare a given document to the sets of jurisdiction rules and custom rules and to output an identification of clauses in the document that violate one or more of the rules. For example, if a form for requesting assistance from a city requires a case identification number to be included on every page of the document to be accepted, the jurisdictional model, will review the document for compliance with the city rules and will identify pages of the document that lack the case identification number.

The training data store 210 stores training data for use by the model training module 205 in generating the machine learning models. Training data may include labeled sample documents and past documents analyzed by the document analysis system. The training data store 210 stores documents associated with various document types.

The model store 215 stores the trained machine learning models that are generated by the model training module 205. The model store 215 stores models for different document types and for different rule sets such as for certain jurisdictions or organizations. Models stored in the model store 215 may be updated by the model training module 205. The models are accessed by the content analysis module 235 and the jurisdiction analysis module 240 for use in reviewing documents.

The jurisdiction API is an application programming interface system that facilitates the automatic retrieval of jurisdictional rule changes. The jurisdiction API may include functions that access rule sets, such as statutes and governmental or organizational rules that are published, for example, to the Internet. In other embodiments, the jurisdictions may make rules available in a format that is shared by the document analysis system 130. The jurisdiction API may additionally or alternatively include parsing methods that convert rules into a format that is recognizable by the document analysis system 130. When a new jurisdiction is added to the document analysis system 130 abilities (e.g., the ability to review documents from a certain state or agency), a system administrator may configure the jurisdiction API to pull any updates to the rules for that jurisdiction for storage in the jurisdiction rule store 225. This allows the updates to the rules to be automatic rather than relying on human operators to add new rules every time a city, county, state, agency, company, or other entity changes a law or a rule that may affect documents. In some cases, it is also possible for jurisdiction rules to be updated by human operators, such as organization administrators.

The jurisdiction rule store 225 stores the rules associated with various document types for various jurisdictions. The jurisdictional models may access the rules in the jurisdiction rule store 225 during training and/or when analyzing a document. In some embodiments, the document analysis system 130 can review documents for compliance with rules of an organization in addition to jurisdictional rules. For example, a potential signatory to a document may be associated with a company that has its own compliance rules about what types and formats of documents employees can sign. This for example, could help to prevent risks to the company from individual employees accepting contracts that are not in the interest of the company. Thus, in addition to jurisdictional rules from government agencies and the like, the jurisdiction rule store 225 may additionally store customized rules associated with certain organizations or entities. These rules would be included along with jurisdictional rules when the document analysis system 130 reviews documents for compliance.

The document intake system 230 receives documents for review from user devices 110 and prepares the documents for analysis by the document analysis system 130. In some embodiments, the document intake system 230 can also retrieve documents from other systems, such as from a document management system on behalf of the user of a user device 110. Documents may include text documents, PDF documents, documents with additional underlying document code or metadata, HyperText Markup Language (HTML) documents, or other formats of document. In addition to contents and formatting of a document, the document intake system 230 can also obtain metadata or other code associated with a document, for example, in the case of dynamic documents that have underlying computing logic that is not necessarily always visible to a user. Such metadata and document code can be analyzed by the document analysis system along with the rest of a document. In some embodiments, the document intake system may compare the document to past documents to determine the document type. In other embodiments, the document intake system 230 receives information from the user of the user device 110 that identifies the document type. For example, a user may select a document type of the document from an interface menu at the time of providing the document for analysis. Additionally, the document intake system 230 collects jurisdiction and organizational data from the user of the user device 110. The document intake system may receive information from a user that identifies a jurisdiction to which the document will apply. For example, the user may indicate that a rental agreement is for an apartment in Oregon, so that Oregon laws and regulations about rental agreements should be used when analyzing the document. The user or the user device 110 may also indicate information about the organization with which the user is associated (e.g., as an employee of a company). The document intake system 230 receives these indications, which can then be used by the document analysis system 130 to determine which models should be used to review the document.

The content analysis module 235 uses trained machine learning models to generate a risk score for a given document. The document intake system 230 provides the document for analysis along with information about the document type to the content analysis module 235. The content analysis module accesses the appropriate content analysis machine learning models stored in the model store 215. The selected content analysis machine learning model is applied to the document to compare the document with similar documents of the document type. The content analysis model produces a risk score that represents a likelihood that differences between the document and prior documents of a similar type are issues that the user should consider for further review before signing or otherwise using the document. In some embodiments, the content analysis model may additionally classify specific clauses within the document as having certain levels of risk. For example, the content analysis module 235 may output an overall risk score for the document and an identification of specific clauses within the document that most differed from documents of the same type in the training data.

The jurisdiction analysis module 240 applies the jurisdictional models to documents. The jurisdiction analysis module 240 receives the document for review along with data about the document type, the document jurisdiction, and any custom organization rules associated with the user from the document intake system 230. The jurisdiction analysis module 240 uses the information received from the document intake system 230 to select an applicable jurisdictional model (or models) from the model store 215 that will be able to analyze the document for compliance with the selected jurisdiction and any applicable organizational rules. Using the selected models, the jurisdiction analysis module 240 outputs a set of clauses within the document are likely to differ from the rules of the jurisdiction and/or from any organizational rules.

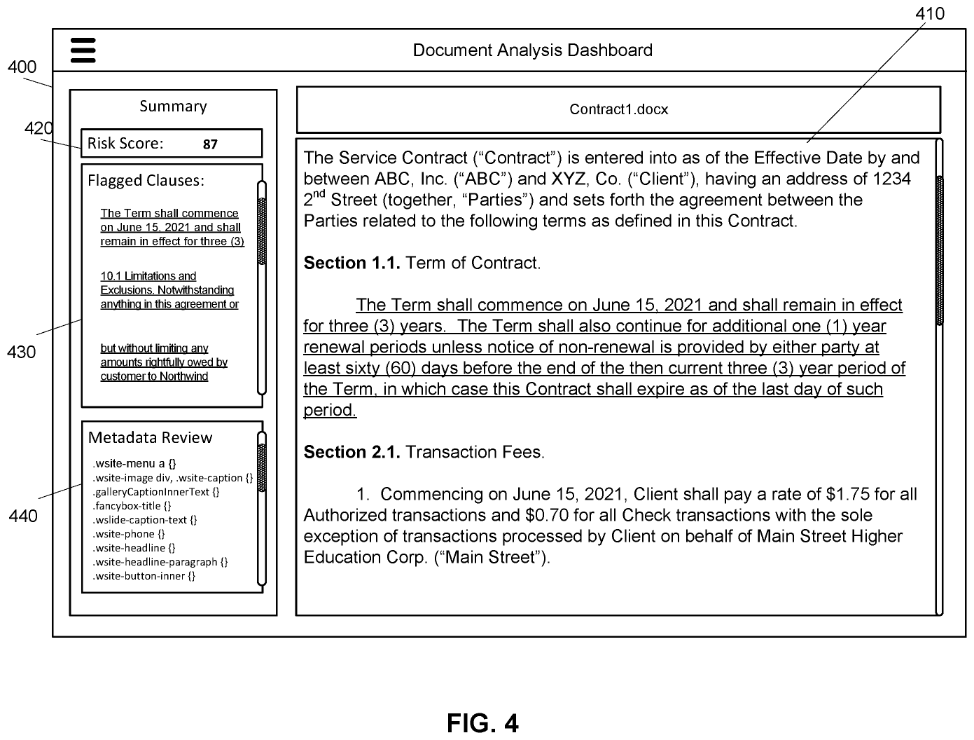

The document profiling module 245 generates a summary of the document analysis based on the outputs of the content analysis module 235 and the jurisdiction analysis module 240. The document summary includes the risk score for the document and an indication of a set of clauses that may need further review. In some embodiments, the document summary may also include information about document metadata such as review of underlying source code of a document that may not be immediately visible to a user of the user device 110 when viewing the document. The document profiling module 245 produces a review interface for the user to review the document summary at the user device 110. More information about the document review interface is included in the description of FIG. 4. The document profiling module 245 provides information for display and rendering of the document summary to the user device 110, which can display the document summary for the user.

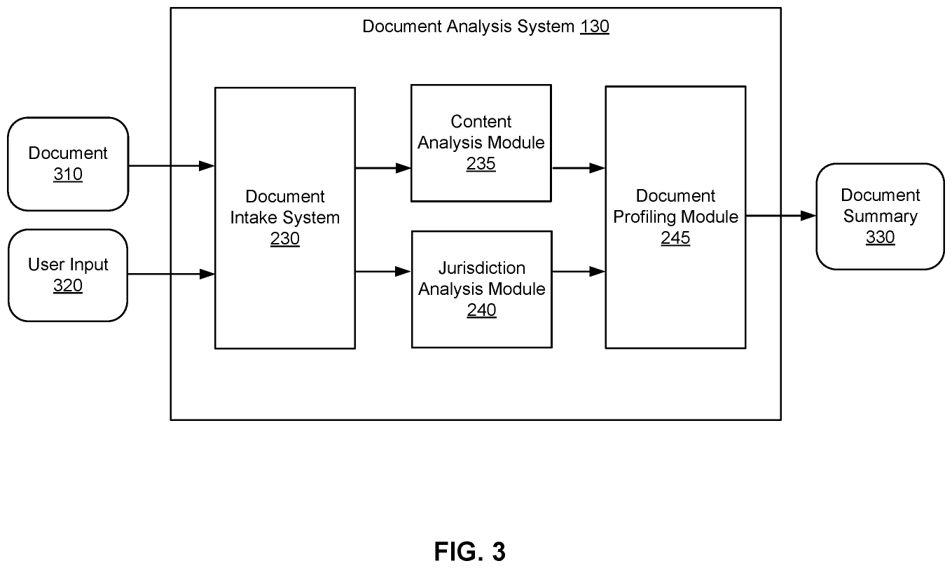

FIG. 3 is a block diagram illustrating a process of analyzing a document by modules of the document analysis system 130, in accordance with an example embodiment. The document analysis system 130 receives, via the document intake system 230, a document 310. In some cases, the document 310 may include underlying code or metadata in addition to text. The document intake system 230 also accepts user input 320 from the user associated with the document, or from the user device 110 associated with the user. The user input 320 may include an identification of the document type and an identification of one or more jurisdictions and/or organizational rulesets that should apply to the review of the document.

The document intake system 230 provides the relevant information to the content analysis module 235 and the jurisdiction analysis module 240 so that these modules can review and analyze the document. In some embodiments, the content analysis module 235 and jurisdiction analysis module 240 may review the document in sequence and the second module may receive the output of the first module to review the document as additional input. The content analysis module 235 accesses machine learning models that are trained to review documents of the same document type as the document 310 received by the document intake system 230. The content analysis module 235 generates a risk score associated with the likelihood that the user will need to review sections of the document for potential issues. The jurisdiction analysis module 240 accesses machine learning models that correspond to the document type of the document 310 and the jurisdiction and custom organizational rules that correspond to the user input 320. In some cases, this may include accessing multiple jurisdictional models that can review the document for compliance with a variety of applicable rule sets. The jurisdiction analysis module 240 outputs a set of clauses of the document that do not comply or are likely to not comply with the jurisdiction and/or organization rules.

The outputs of the content analysis module 235 and the jurisdiction analysis module 240 are provided to the document profiling module 245. The document profiling module 245 generates a document summary 330 that includes information that can be used to render information about the document analysis for display to a user at a user device 110. The document summary 330 includes the risk score generated by the content analysis module 235, information about the set of potentially problematic clauses identified by the jurisdiction analysis module 240 and may additionally include information about document metadata that may not comply with jurisdictional or organizational rules.

FIG. 4 illustrates an example user interface 400 for reviewing a document summary, in accordance with an embodiment. The contents of the user interface 400 are provided by the document profiling module 245 of the document analysis system 130. A user can view and interact with the user interface 400 via a user device 110. In the example of FIG. 4, the user interface 400 includes a document review pane 410 where the user can view the contents of the document. The user interface 400 also includes a summary of the document analysis performed by the document analysis system 130. In the example of FIG. 4, the summary includes a risk score 420, a set of flagged clauses 430, and a metadata review section 440. The risk score 420 displays the risk score predicted by the content analysis module. In some embodiments, rather than a specific numeric score, the risk score may be represented by a color-coded gradient (e.g., green means that the document is low risk and red means that the document should be reviewed in more detail before the user signs). The panel displaying the set of flagged clauses 430 identifies clauses that are significantly different from clauses in other documents of the same type, clauses that do not comply with jurisdictional rules, and clauses that do not comply with organizational rules. In some embodiments, as shown by the underlining in FIG. 4, the flagged clauses 430 can link the user to the portion of the document that includes a flagged clause for viewing in the document review pane 410. In some cases, the user interface further includes a metadata review section 440 that displays information about metadata or other document code that may differ from that of other documents of the same document type or that may not be in compliance with jurisdictional rules.

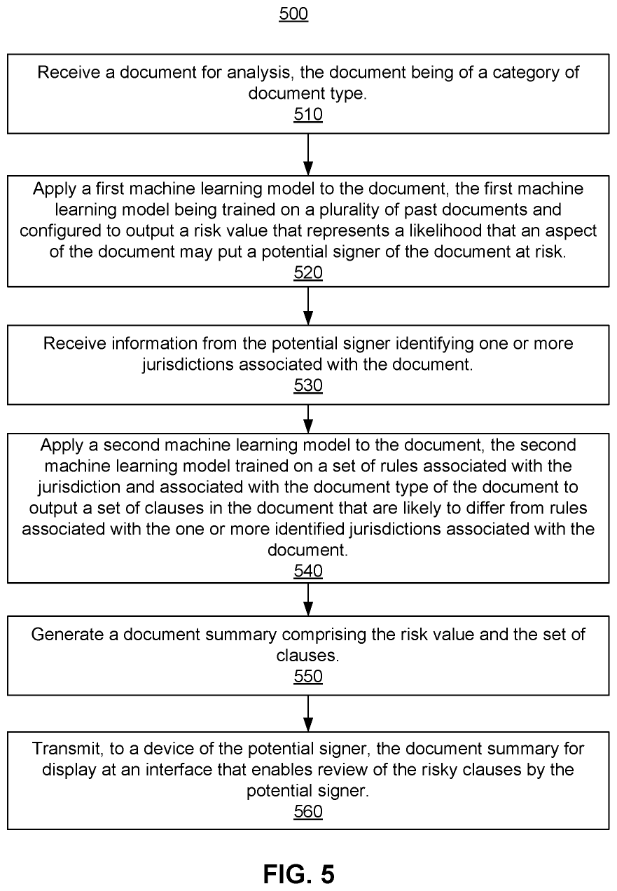

FIG. 5 is a flow diagram illustrating a process of analyzing a document and generating a document summary, in accordance with an example embodiment. The document intake system 230 of the document analysis system 130 receives 510 a document for analysis. The document has a document type and/or may be of a category of document type.

The content analysis module 235 applies 520 a first machine learning model (i.e., a content analysis model) to the document. The first machine learning model is trained on training data comprising a plurality of past documents and is configured to output a risk value (e.g., a risk score) that represents a likelihood that an aspect of the document may put a potential signer of the document at risk. For example, a document may be risky to sign if it differs significantly from other documents of the same category of document because this may mean the signer would be agreeing to certain clauses that are not usually required of the type of document.

In addition to the document, the document analysis system 130 receives 530 information from the potential signer (e.g., a user) identifying one or more jurisdictions associated with the document. For example, the potential signer may indicate a city, state, province, county, agency, country, or other jurisdiction associated with the document for review. The potential signer may also identify organizational rules that should apply to the document, such as by indicating that they are an employee signing the document on behalf of a company that has certain organizational rules.

The jurisdiction analysis module applies 540 a second machine learning model (e.g., a jurisdictional model) to the document. The second machine learning model is trained on a set of rules associated with the jurisdiction and is associated with the document type of the document. The second machine learning model is trained to output a set of clauses in the document that are likely to differ from rules associated with the one or more identified jurisdictions associated with the document.

Based on the outputs of the first machine learning model and the second machine learning model, the document profiling module 245 generates 550 a document summary comprising the risk value and the set of clauses. The document analysis system 130 transmits 560 the document summary to a device of the potential signer for display at an interface that enables review of the risky clauses by the potential signer.

Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, by a document management system, a document for analysis, the document being of a category of document type;
applying, by the document management system, a first machine learning model to the document, the first machine learning model trained on a plurality of past documents and configured to output a risk value that represents a likelihood that an aspect of the document may put a potential signer of the document at risk;
receiving, by the document management system, information from the potential signer identifying one or more jurisdictions associated with the document;
applying, by the document management system, a second machine learning model to the document, the second machine learning model trained on a set of rules associated with the jurisdiction and associated with the document type of the document to output a set of clauses in the document that are likely to differ from rules associated with the one or more identified jurisdictions associated with the document;
generating, by the document management system, a document summary comprising the risk value and the set of clauses; and
transmitting, by the document management system, to a device of the potential signer, the document summary for display at an interface that enables review of the risky clauses by the potential signer.

2. The method of claim 1, wherein the plurality of past documents used to train the first machine learning model are labeled with training data indicating clause types and document types.

3. The method of claim 1, wherein the set of rules associated with the jurisdiction is obtained using functions of an application programming interface (API) that obtain changes to rules associated with the jurisdiction.

4. The method of claim 1, further comprising:
receiving metadata associated with the document for analysis; and
applying the first machine learning model and the second machine learning model to the metadata;
wherein the document summary further comprises information about the metadata.

5. The method of claim 1, wherein the document is a HyperText Markup Language (HTML) document.

6. The method of claim 1, further comprising storing, for each of a set of jurisdictions, example documents that conform to the rules of the jurisdiction, for use in training the first machine learning model and the second machine learning model.

7. The method of claim 1, wherein the first machine learning model and the second machine learning model are further trained according to organizational rules set by an administrator of an organization associated with the potential signer.

8. A non-transitory computer-readable storage medium storing executable instructions that, when executed by a hardware processor of a central networking system, cause the central networking system to perform steps comprising:
receiving, by a document management system, a document for analysis, the document being of a category of document type;
applying, by the document management system, a first machine learning model to the document, the first machine learning model trained on a plurality of past documents and configured to output a risk value that represents a likelihood that an aspect of the document may put a potential signer of the document at risk;
receiving, by the document management system, information from the potential signer identifying one or more jurisdictions associated with the document;
applying, by the document management system, a second machine learning model to the document, the second machine learning model trained on a set of rules associated with the jurisdiction and associated with the document type of the document to output a set of clauses in the document that are likely to differ from rules associated with the one or more identified jurisdictions associated with the document;
generating, by the document management system, a document summary comprising the risk value and the set of clauses; and
transmitting, by the document management system, to a device of the potential signer, the document summary for display at an interface that enables review of the risky clauses by the potential signer.

9. The non-transitory computer-readable storage medium of claim 8, wherein the plurality of past documents used to train the first machine learning model are labeled with training data indicating clause types and document types.

10. The non-transitory computer-readable storage medium of claim 8, wherein the set of rules associated with the jurisdiction is obtained using functions of an application programming interface (API) that obtain changes to rules associated with the jurisdiction.

11. The non-transitory computer-readable storage medium of claim 8, the steps further comprising:
receiving metadata associated with the document for analysis; and
applying the first machine learning model and the second machine learning model to the metadata;
wherein the document summary further comprises information about the metadata.

12. The non-transitory computer-readable storage medium of claim 8, wherein the document is a HyperText Markup Language (HTML) document.

13. The non-transitory computer-readable storage medium of claim 8, the steps further comprising storing, for each of a set of jurisdictions, example documents that conform to the rules of the jurisdiction, for use in training the first machine learning model and the second machine learning model.

14. The non-transitory computer-readable storage medium of claim 8, wherein the first machine learning model and the second machine learning model are further trained according to organizational rules set by an administrator of an organization associated with the potential signer.

15. A system comprising a hardware processor and a non-transitory computer-readable storage medium storing executable instructions that, when executed by the hardware processor, cause the system to perform steps comprising:
receiving, by a document management system, a document for analysis, the document being of a category of document type;
applying, by the document management system, a first machine learning model to the document, the first machine learning model trained on a plurality of past documents and configured to output a risk value that represents a likelihood that an aspect of the document may put a potential signer of the document at risk;
receiving, by the document management system, information from the potential signer identifying one or more jurisdictions associated with the document;
applying, by the document management system, a second machine learning model to the document, the second machine learning model trained on a set of rules associated with the jurisdiction and associated with the document type of the document to output a set of clauses in the document that are likely to differ from rules associated with the one or more identified jurisdictions associated with the document;
generating, by the document management system, a document summary comprising the risk value and the set of clauses; and
transmitting, by the document management system, to a device of the potential signer, the document summary for display at an interface that enables review of the risky clauses by the potential signer.

16. The system of claim 15, wherein the plurality of past documents used to train the first machine learning model are labeled with training data indicating clause types and document types.

17. The system of claim 15, wherein the set of rules associated with the jurisdiction is obtained using functions of an application programming interface (API) that obtain changes to rules associated with the jurisdiction.

18. The system of claim 15, the steps further comprising:
receiving metadata associated with the document for analysis; and
applying the first machine learning model and the second machine learning model to the metadata;
wherein the document summary further comprises information about the metadata.

19. The system of claim 15, wherein the document is a HyperText Markup Language (HTML) document.

20. The system of claim 15, wherein the first machine learning model and the second machine learning model are further trained according to organizational rules set by an administrator of an organization associated with the potential signer.
